(19) United States
(12) Patent Application Publication
(10) Pub. No.: US 2014/0093792 A1
(43) Pub. Date: Apr. 3, 2014

(54) SOLID POLYMER ELECTROLYTE MEMBRANE AND FUEL CELL USING THE SAME

(71) Applicant: Hitachi, Ltd., Tokyo (JP)

(72) Inventors: Yoshiyuki TAKAMORI, Tokyo (JP); Atsuhiko ONUMA, Tokyo (JP)

(73) Assignee: Hitachi, Ltd., Tokyo (JP)

(21) Appl. No.: 13/957,952

(22) Filed: Aug. 2, 2013

(30) Foreign Application Priority Data
Sep. 28, 2012 (JP) 2012-215468

(51) Int. Cl. H01M 8/10

(52) U.S. Cl. CPC H01M 8/1044
USPC 429/408; 429/492; 429/482

(57) ABSTRACT

A solid polymer electrolyte membrane is provided that is inexpensive, and is excellent in the ionic conductivity characteristics, the methanol crossover characteristics and the mechanical characteristics. The solid polymer electrolyte membrane contains a block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A, and has a structure where a region A having the block copolymer A agglomerated therein is dispersed in a matrix constituted by a region B having the block copolymer B agglomerated therein, with a microscopic phase-separated structure having a period of from 10 to 100 nm being formed in the region A and the region B.

### BACKGROUND OF THE INVENTION

1. Field of the Invention

The present invention relates to a solid polymer electrolyte membrane and a fuel cell using the same.

2. Related Art

A fluorinated polymer electrolyte membrane having high proton conductivity has been known as a solid polymer electrolyte membrane for a fuel cell, but the fluorinated polymer electrolyte membrane is considerably expensive. The fluorinated polymer electrolyte membrane generates hydrofluoric acid on combustion for disposal. Furthermore, the fluorinated polymer electrolyte membrane may not be used under a high temperature of 100° C. or more due to decrease of the ionic conductivity thereof. Moreover, on using as an electrolyte membrane of a direct methanol fuel cell (which may be hereinafter referred to as DMFC), the fluorinated polymer electrolyte membrane may cause voltage drop and deterioration of the power generation efficiency due to methanol crossover.

As a solid polymer electrolyte membrane for a fuel cell, accordingly, a hydrocarbon polymer electrolyte membrane formed of a polyethersulfone polymer or a polyetherketone polymer, which is inexpensive, have been used in addition to the fluorinated polymer electrolyte membrane. For enhancing the characteristics of the hydrocarbon polymer electrolyte membrane, such as the proton conductivity, the water resistance and the mechanical characteristics, a block copolymer membrane having a phase-separated structure containing a hydrophobic segment and a hydrophilic segment has been developed (see, for example, JP-A-2009-252471).

However, the ordinary method described above is still insufficient in the ionic conductivity, the methanol crossover characteristics, the mechanical characteristics and the like, and thus an electrolyte membrane that is further enhanced in the ionic conductivity and the methanol crossover characteristics has been demanded for enhancing the capability and the efficiency of the fuel cell.

### SUMMARY OF THE INVENTION

An object of the invention is to provide a solid polymer electrolyte membrane that is inexpensive, and is excellent in the ionic conductivity characteristics, the methanol crossover characteristics and the mechanical characteristics.

Under the circumstances, the present inventors have made development of a solid polymer electrolyte membrane that is excellent in the ionic conductivity characteristics, the methanol crossover characteristics and the mechanical characteristics. As a result of earnest investigations made by the inventors for achieving the aforementioned and other objects of the invention, it has been found that a hydrocarbon electrolyte membrane exhibits ionic conductivity characteristics, methanol crossover characteristics and mechanical characteristics that are particularly high in the case where the hydrocarbon electrolyte membrane has the structure described below.

The invention relates to, as one aspect, a solid polymer electrolyte membrane containing a block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A, and having a structure where a region A having the block copolymer A agglomerated therein is dispersed in a matrix constituted by a region B having the block copolymer B agglomerated therein, with a microscopic phase-separated structure having a period of from 10 to 100 nm being formed in the region A and the region B.

According to the invention, a solid polymer electrolyte membrane may be provided that is inexpensive, and is excellent in the ionic conductivity characteristics, the methanol crossover characteristics and the mechanical characteristics.

### BRIEF DESCRIPTION OF THE DRAWINGS

FIG. 1 is a scanning transmission electron micrograph of a solid polymer electrolyte membrane of Example 1.

FIG. 2 is another scanning transmission electron micrograph of a solid polymer electrolyte membrane of Example 1.

FIG. 3 is a scanning transmission electron micrograph of a solid polymer electrolyte membrane of Comparative Example 1.

FIG. 4 is another scanning transmission electron micrograph of a solid polymer electrolyte membrane of Comparative Example 1.

### DESCRIPTION OF EMBODIMENTS

The invention relates to, in one embodiment, a fuel cell, and in particular, a solid polymer electrolyte membrane used in a direct methanol fuel cell (DMFC), which is one kind of a polymer electrolyte fuel cell, and a polymer electrolyte fuel cell (PEFC).

As a result of earnest investigations made by the inventors on an electrolyte membrane for a polymer electrolyte fuel cell, it has been found that a solid polymer electrolyte membrane may exhibit ionic conductivity characteristics, methanol crossover characteristics and mechanical characteristics that are particularly high in the case where the hydrocarbon electrolyte membrane has the following, structure. That is, the solid polymer electrolyte membrane contains a block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A, and the solid polymer electrolyte membrane has a structure where a region A having the block copolymer A agglomerated therein is dispersed in a matrix constituted by a region B having the block copolymer B agglomerated therein, with a microscopic phase-separated structure having a period of from 10 to 100 nm being formed in the region A and the region B. The region A is a region where the block copolymer A is mainly agglomerated, and the region A may contain the block copolymer B. The region B is a region where the block copolymer B is mainly agglomerated, and the region B may contain the block copolymer A. In other words, the structure contains a matrix and, dispersed in the matrix, a region that has a larger ion exchange capacity than the matrix, and a microscopic phase-separated structure having a period of from 10 to 100 nm is formed in the matrix and the region. The phase separation between the region A and the region B herein is referred to as macroscopic phase separation for distinguishing from the microscopic phase separation inside the region A and the region B.

The block copolymer herein is a copolymer containing at least one kind of a hydrophilic segment and at least one kind of a hydrophobic segment that are covalently bonded to each other directly or indirectly.

The hydrophilic segment is a polymer that has a proton conductive group, such as a sulfonic acid group, and an ion exchange group for ionic conduction, for example, an anion exchange group, such as a quaternary amine group, and has an ion exchange capacity of 1.0 meq/g or more. The hydrophobic segment is a polymer that has an ion exchange capacity of 1.0 meq/g or less, i.e., an ion exchange capacity that is smaller than that of the hydrophilic segment.

The ion exchange capacity herein means an ion exchange amount per unit weight of an ion exchange material, and is generally expressed in terms of milliequivalent per 1 g of an ion exchange material (meq/g), a larger value of which means a larger amount of the ion exchange group introduced. The ion exchange capacity may be measured by ¹H-NMR spectroscopy, elemental analysis, acid-base titration described in JP-B-1-52866, nonaqueous acid-base titration (with a benzene-methanol solution of potassium methoxide as a normal solution), and the like.

The microscopic phase-separated structure in the solid polymer electrolyte membrane means a phase-separated structure that is formed by the presence of a microscopic domain having a larger amount of the ionic conduction component due to the hydrophilic segment agglomerated and a microscopic domain having a smaller amount of the ionic conduction component due to the hydrophobic segment agglomerated. The microscopic phase-separated structure has a structure that is phase-separated corresponding to the sizes of the molecular chains of the hydrophilic segment and the hydrophobic segment, and has a periodic structure with a period of from 10 to 100 nm.

Examples of the hydrophobic segment used in the invention include an aromatic hydrocarbon polymer, such as a polyimide copolymer, a polybenzoimidazole copolymer, a polyquinoline copolymer, a polysulfone copolymer, a polyethersulfone copolymer, a polyether ether ketone copolymer, a polyether ketone copolymer, a polyphenylene sulfide copolymer and a polyetherimide copolymer, to which a substituent may be attached, and further to which sulfonic acid, an alkylsulfonic acid, an alkyloxysulfonic acid, an oxysulfonic acid or the like may be attached.

Examples of the hydrophilic segment used in the invention include electrolytes, for example, a sulfonated engineering plastics electrolyte, such as a polyether ether ketone copolymer having a sulfonic acid group, a polyethersulfone copolymer having a sulfonic acid group, a polysulfide copolymer having a sulfonic acid group, a polyphenylene copolymer having a sulfonic acid group, a polyimide copolymer having a sulfonic acid group, a polybenzoimidazole copolymer having a sulfonic acid group and a polyquinoline copolymer having a sulfonic acid group, an engineering plastics electrolyte having an alkylsulfonic acid group, such as a polyether ether ketone copolymer having an alkylsulfonic acid group, a polyethersulfone copolymer having an alkylsulfonic acid group, a polyether ether sulfone copolymer having an alkylsulfonic acid group, a polysulfone copolymer having an alkylsulfonic acid group, a polysulfide copolymer having an alkylsulfonic acid group, a polyphenylene copolymer having an alkylsulfonic acid group, a polyimide copolymer having an alkylsulfonic acid group, a polybenzoimidazole copolymer having an alkylsulfonic acid group and a polyquinoline copolymer having an alkylsulfonic acid group, an engineering plastics electrolyte having an alkyloxysulfonic acid group, such as a polyether ether ketone copolymer having an alkyloxysulfonic acid group, a polyethersulfone copolymer having an alkyloxysulfonic acid group, a polyether ether sulfone copolymer having an alkyloxysulfonic acid group, a sulfoalkylated polysulfone copolymer having an alkyloxysulfonic acid group, a sulfoalkylated polysulfide copolymer having an alkyloxysulfonic acid group and a sulfoalkylated polyphenylene copolymer having an alkyloxysulfonic acid group, and an engineering plastics electrolyte having an oxysulfonic acid group, such as a polyether ether ketone copolymer having an oxysulfonic acid group, a polyethersulfone copolymer having an oxysulfonic acid group, a polyether ether sulfone copolymer having an oxysulfonic acid group, a sulfoalkylated polysulfone copolymer having an oxysulfonic acid group, a sulfoalkylated polysulfide copolymer having an oxysulfonic acid group and a sulfoalkylated polyphenylene copolymer having an oxysulfonic acid group, to which a substituent may be attached.

When the ion exchange capacity of the total solid polymer electrolyte membrane is less than 0.3 meq/g, the output power of the fuel cell maybe decreased due to the large resistance of the electrolyte membrane on power generation of the fuel cell, and when it exceeds 5.0 meq/g, the mechanical characteristics maybe deteriorated, both cases of which are not preferred. Accordingly, the total ion exchange capacity of the solid polymer electrolyte membrane is preferably from 0.3 to 5.0 meq/g for providing an electrolyte membrane having excellent mechanical characteristics and for providing a polymer electrolyte fuel cell having high power output.

The polymer material used in the solid polymer electrolyte membrane may have a number average molecular weight of from 10,000 to 250,000 g/mol, preferably from 20,000 to 220,000 g/mol, and further preferably from 25,000 to 200,000 g/mol, in terms of polystyrene conversion number average molecular weight measured by a GPC method. When the number average molecular weight is less than 10,000 g/mol, the strength of the electrolyte membrane maybe deteriorated, and when it exceeds 250,000 g/mol, the output capability may be lowered, both cases of which are not preferred.

The polymer material used in the solid polymer electrolyte membrane is used in the form of a polymer membrane. Examples of the production method of the polymer membrane include a solution casting method where a membrane is formed from a solution, a melt pressing method and a melt extrusion method. Among these, a solution casting method is preferred, and for example, a polymer solution is flow-cast by coating on a substrate and then the solvent is removed to form a membrane.

The solvent used in the solution casting method is not particularly limited as far as the solvent can be removed after dissolving the polymer material, and examples thereof include a non-protonic polar solvent, an alkylene glycol monoalkyl ether, an alcohol and tetrahydrofuran.

Examples of the non-protonic polar solvent include N,N-dimethylformamide, N,N-dimethylacetamide, N-methyl-2-pyrrolidone and dimethylsulfoxide. Examples of the alkylene glycol monoalkyl ether include ethylene glycol monomethyl ether, ethylene glycol monoethyl ether, propylene glycol monomethyl ether and propylene glycol monoethyl ether. Examples of the alcohol include isopropyl alcohol and tert-butyl alcohol.

A representative example of the production method of the solid polymer electrolyte membrane of the invention is as follows. A block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A are dissolved in a solvent to form a solution, and the solution is coated on a flat plate, and then heated and dried to form the membrane. By using two kinds of block copolymers having different ion exchange capacities, a solid polymer electrolyte membrane may be obtained that has both the macroscopic phase-separated structure and the microscopic phase-separated structure.

The thickness of the solid polymer electrolyte membrane is preferably from 10 to 300 μm, and particularly preferably from 15 to 200 μm, while not being limited. The thickness is preferably 10 μm or more for providing a membrane capable of withstanding the practical use, and the thickness is preferably 200 μm or less for decreasing the resistance of the membrane, i.e., for enhancing the electric power generation capability. In the case where the membrane is formed by the solution casting method, the thickness of the membrane maybe controlled by the concentration of the solution or the coated thickness on the substrate. In the case where the membrane is formed from a molten state, the thickness of the membrane may be controlled by providing a membrane having a predetermined thickness by the melt pressing method or the melt extrusion method, and then stretching the resulting membrane in a predetermined ratio.

The solid polymer electrolyte membrane of the invention may be applied to various types of fuel cells. For example, a cathode and an anode are formed on both surfaces, respectively, of the solid polymer electrolyte membrane of the invention to provide a membrane-electrode assembly. Gas diffusion layer are provided on the cathode side and the anode side of the membrane-electrode assembly, respectively, and electroconductive separators having a gas feeding channel to the cathode or anode are provided on surfaces of the gas diffusion layer, respectively, thereby completing a single-cell polymer electrolyte fuel cell. Plural single-cell polymer electrolyte fuel cells may be stacked to provide a polymer electrolyte fuel cell stack. The use of the solid polymer electrolyte membrane of the invention which is excellent in methanol crossover characteristics enables the use of a fuel having a higher concentration, thereby providing a fuel cell having higher output power. The solid polymer electrolyte membrane of the invention has excellent mechanical characteristics, and thus is prevented from suffering breakage or the like on swelling, thereby providing a fuel cell having a prolonged service life.

The invention will be described in more detail with reference to examples below, but the substance of the invention is not limited to the examples.

### EXAMPLE 1

### (1) Production of Polymer a (Hydrophobic Segment)

The interior of a 1,000-mL four-neck round-bottom flask equipped with a stirrer, a thermometer and a reflux condenser connected to a calcium chloride tube was replaced with nitrogen, and then 4,4-dichlorodiphenylsulfone, 4,4-bisphenol and potassium carbonate were placed therein at a molar ratio of 1.00/1.05/1.15. The mixture was reacted at 200° C. for 24 hours with toluene as an azeotropic agent and N-methyl-2-pyrrolidone (NMP) as a solvent, thereby synthesizing a polymer having OH as the terminal group. Decafluorobiphenyl was added thereto at a molar ratio of 0.1 to convert the terminal of the polymer to F entirely. The resulting hydrophobic segment had a number average molecular weight Mn of 2.0×10⁴ and a weight average molecular weight Mw of 4.4×10⁴ (polystyrene conversion values obtained by GPC).

The measurement conditions for GPC (gel permeation chromatography) were as follows.
GPC equipment: HLC-8220GPC (available from Tohso Corporation)
Columns: TSKgel Super AWM-H×2 (available from Tohso Corporation)
Eluent: NMP (containing 10 mmol/L of lithium bromide)

### (2) Production of Polymer b (Hydrophilic Segment)

The interior of a 1,000-mL four-neck round-bottom flask equipped with a stirrer, a thermometer and a reflux condenser connected to a calcium chloride tube was replaced with nitrogen, and then sulfonated 4,4-dichlorodiphenylsulfone, 4,4-bisphenol and potassium carbonate were placed therein at a molar ratio of 1.60/1.65/1.15. The mixture was reacted at 200° C. for 12 hours with toluene and N-methyl-2-pyrrolidone (NMP) as solvents, thereby synthesizing a polymer having OH as the terminal group. The resulting hydrophilic segment had a number average molecular weight Mn of 3.3×10⁴ and a weight average molecular weight Mw of 8.1×10⁴.

### (3) Production of Block Copolymer a

The polymer a synthesized in (1) and the polymer b synthesized in (2) were mixed and reacted at 140° C. for 2 hours. The mixing ratio of the polymer a and the polymer b was determined to make an ion exchange capacity of 1.60 meq/g. The resulting solution was placed in water for reprecipitation, thereby providing a block copolymer a. The resulting block copolymer a had a number average molecular weight Mn of 1.1×10⁵ and a weight average molecular weight Mw of 4.4×10⁵. The ion exchange capacity thereof measured by acid-base titration was 1.46 meq/g.

### (4) Production of Polymer c (Hydrophobic Segment)

A hydrophobic segment having a number average molecular weight Mn of 1.2×10⁴ and a weight average molecular weight Mw of 2.5×10⁴ was produced in the same manner as in (1) except that the ratio of 4,4-dichlorodiphenylsulfone, 4,4-bisphenol potassium carbonate and decafluorobiphenyl was changed.

### (5) Production of Polymer d (Hydrophilic Segment)

A hydrophilic segment having a number average molecular weight Mn of 2.6×10⁴ and a weight average molecular weight Mw of 5.8×10⁴ was produced in the same manner as in (2) except that the ratio of 4,4-dichlorodiphenylsulfone, 4,4-bisphenol and potassium carbonate was changed.

### (6) Production of Block Copolymer b

The polymer c synthesized in (4) and the polymer d synthesized in (5) were mixed and reacted at 140° C. for 2 hours in the same manner as in (3) above. The mixing ratio of the polymer c and the polymer d was determined to make an ion exchange capacity of 0.91 meq/g. The resulting block copolymer b had a number average molecular weight Mn of 9.3×10⁴ and a weight average molecular weight Mw of 2.3×10⁵. The ion exchange capacity thereof measured by acid-base titration was 0.93 meq/g.

### (7) Production of Polymer Electrolyte Membrane and Characteristics Thereof

The block copolymer a obtained in (3) and the block copolymer b obtained in (6) were dissolved in NMP at a ratio of 4/5 (total solid fraction: 16% by weight). The solution was flow-cast by coating on a glass plate, followed by drying under heating, and the membrane was then immersed in sulfuric acid and water, followed by drying, thereby providing a polymer electrolyte membrane having a thickness of 45 μm.

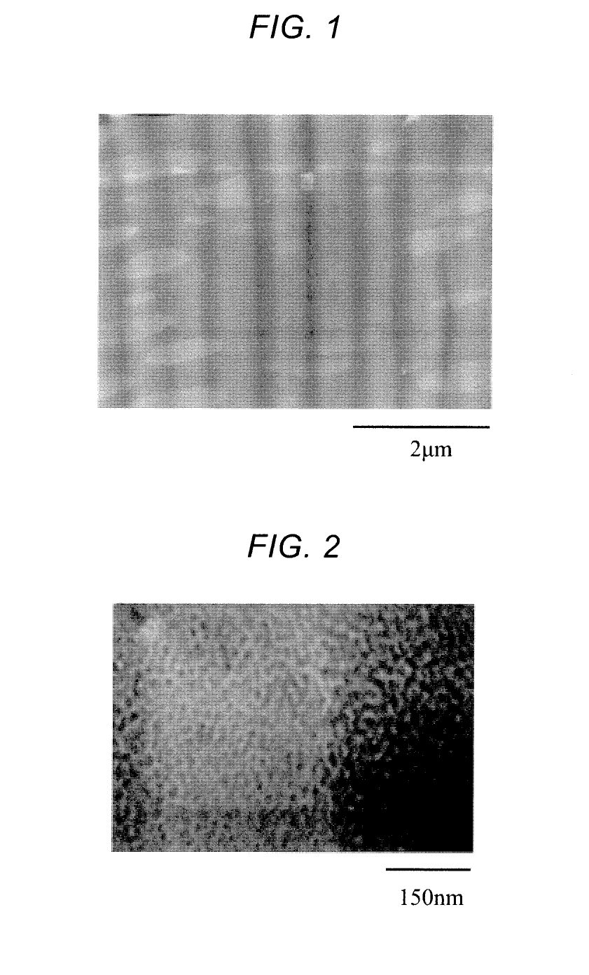

The polymer electrolyte membrane produced in this example, in which the proton of the sulfonic acid group had been exchanged with Cs, was sliced into a thin section with a cooling microtome (EM FC6, available from Leica Biosystems), and observed for the microscopic phase-separated structure with a scanning transmission electron microscope (HD-2000, available from Hitachi High-Technologies Corporation). FIGS. 1 and 2 show scanning transmission electron micrographs of the polymer electrolyte membrane of this example. It is understood from FIG. 1 that bright portions having a size of several micrometers with certain contrast are dispersed in the electrolyte membrane. The bright portions are derived from Cs, which substitutes the proton of the sulfonic acid group, and thus show the portions that contain the sulfonic acid group in a larger amount. The size of the bright portions is several micrometers, and thus this means a macroscopic phase-separated structure where the block copolymer a and the block copolymer b are phase-separated, but not a microscopic phase-separated structure derived from the molecular chains of the segments in each of the block copolymers a and b. The bright portions are the region A having the block copolymer a having a larger ion exchange capacity agglomerated therein, and the dark portions are the region B having the block copolymer b having a smaller ion exchange capacity agglomerated therein. FIG. 2 shows an enlarged image of the bright portion in FIG. 1, and it is confirmed therefrom that the hydrophilic segment and the hydrophobic segment form a phase-separated structure with a size of from 10 to 50 nm. While not shown in the figures, an enlarged image of the dark portion shows that the hydrophilic segment and the hydrophobic segment form a phase-separated structure with a size of from 10 to 50 nm. It is understood from these results that the polymer electrolyte membrane of this example has a structure that exhibits both the microscopic phase-separated structure in nanometer order derived from the molecular chains of the segments in each of the block copolymers a and b, and the macroscopic phase-separated structure in micrometer order. The macroscopic phase separation herein means phase separation between the region A having mainly the block copolymer A agglomerated therein and the region B having mainly the block copolymer B agglomerated therein, and is caused by the low compatibility between the block copolymer a and the block copolymer b having different ion exchange capacities. Accordingly, the polymer electrolyte membrane of this example has such a structure that the region A having mainly the block copolymer a agglomerated therein is dispersed in the matrix constituted by the region B having mainly the block copolymer b agglomerated therein (FIG. 1), and furthermore, the hydrophilic segment and the hydrophobic segment exhibit the microscopic phase-separated structure in each of the region A and the region B.

The polymer electrolyte membrane of this example was measured for the dimensional change in the membrane surface direction after immersing in water at 80° C. for 8 hours, and the dimensional change was 2%. The polymer electrolyte membrane was measured for the ionic conductivity at 10 KHz by a four-terminal alternating current impedance method in a 1 M methanol aqueous solution at 60° C., and the ionic conductivity was 8.9×10⁻² S/cm. The polymer electrolyte membrane was measured for the methanol crossover coefficient in a 1 M methanol aqueous solution at 80° C., and the methanol crossover coefficient was 12.2 mg·μm/cm²·min·mg. The measurement results are shown in Table 1-1.

### EXAMPLE 2

The block copolymer a obtained in (3) and the block copolymer b obtained in (6) were dissolved in NMP at a ratio of 3/7 (total solid fraction: 16% by weight). The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was confirmed for the phase-separated structures, and thus had a structure where microscopic phase separation in nanometer order and macroscopic phase separation in micrometer order were exhibited, as similar to Example 1. The macroscopic phase separation herein was such a structure that the region A having mainly the block copolymer a agglomerated therein was dispersed in the matrix constituted by the region B having mainly the block copolymer b agglomerated therein, as similar to Example 1.

The polymer electrolyte membrane of this example was measured for the characteristics in the same manner as in Example 1. The measurement results are shown in Table 1-1.

### EXAMPLE 3

The block copolymer a obtained in (3) and the block copolymer b obtained in (6) both in Example 1 were dissolved in NMP at a ratio of 1/3 (total solid fraction: 16% by weight) . The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was confirmed for the phase-separated structures, and thus had a structure where microscopic phase separation in nanometer order and macroscopic phase separation in micrometer order were exhibited, as similar to Example 1. The macroscopic phase separation herein was such a structure that the region A having mainly the block copolymer a agglomerated therein was dispersed in the matrix constituted by the region B having mainly the block copolymer b agglomerated therein, as similar to Example 1.

The polymer electrolyte membrane of this example was measured for the characteristics in the same manner as in Example 1. The measurement results are shown in Table 1-1.

### EXAMPLE 4

### (1) Production of Block Copolymer c

In the same manner as in (3) of Example 1, the polymer a synthesized in (1) and the polymer b synthesized in (2) both in Example 1 were mixed and reacted at 140° C. for 2 hours. The mixing ratio of the polymer a and the polymer b was determined to make an ion exchange capacity of 1.05 meq/g. The resulting block copolymer c had a number average molecular weight Mn of 1.1×10⁵ and a weight average molecular weight Mw of 3.9×10⁵. The ion exchange capacity thereof measured by acid-base titration was 1.02 meq/g.

### (2) Production of Polymer Electrolyte Membrane and Characteristics Thereof

The block copolymer a obtained in (3) in Example 1 and the block copolymer b obtained in (1) above were dissolved in NMP at a ratio of 4/5 (total solid fraction: 16% by weight) . The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was confirmed for the phase-separated structures, and thus had a structure where microscopic phase separation in nanometer order and macroscopic phase separation in micrometer order were exhibited, as similar to Example 1. The macroscopic phase separation herein was such a structure that the region A having mainly the block copolymer a agglomerated therein was dispersed in the matrix constituted by the region B having mainly the block copolymer c agglomerated therein, as similar to Example 1.

The polymer electrolyte membrane of this example was measured for the characteristics in the same manner as in Example 1. The measurement results are shown in Table 1-1.

### COMPARATIVE EXAMPLE 1

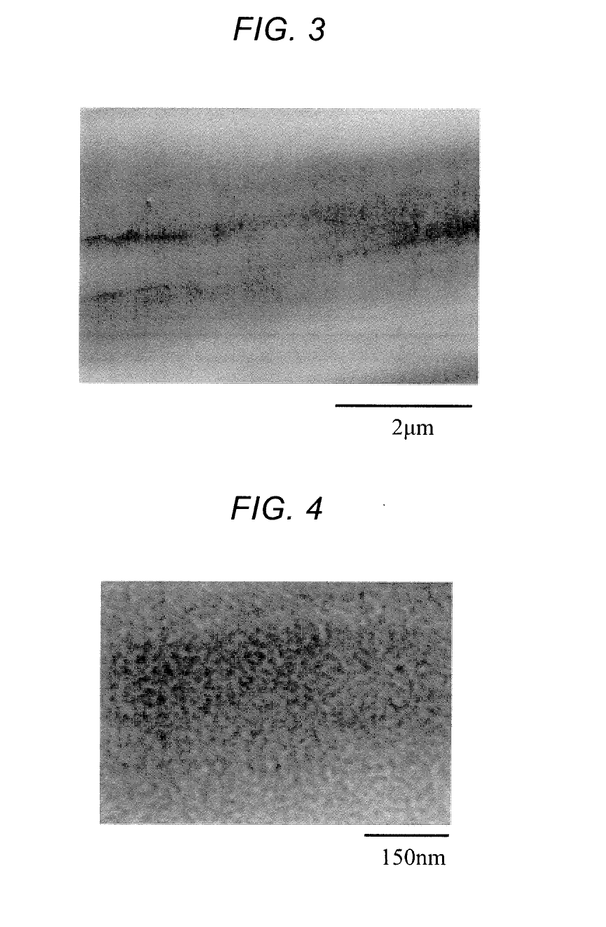

The block copolymer a obtained in (3) in Example 1 was dissolved in NMP to a concentration of 16% by weight. The solution was flow-cast by coating on a glass plate, followed by drying under heating, and the membrane was then immersed in sulfuric acid and water, followed by drying, thereby providing a polymer electrolyte membrane having a thickness of 45 μm. The resulting polymer electrolyte membrane was observed for the phase-separated structures in the same manner as in Example 1. FIGS. 3 and 4 show scanning transmission electron micrographs of the polymer electrolyte membrane of this comparative example. It was understood from FIG. 3 that the polymer electrolyte membrane did not have the contrast in brightness with a size of several micrometers, which was found in the polymer electrolyte membrane of Example 1, but had a homogeneous structure. It was confirmed from the enlarged micrograph in FIG. 4 that the hydrophilic segment and the hydrophobic segment exhibited a microscopic phase-separated structure with a size of from 10 to 50 nm, as similar to Example 1.

The polymer electrolyte membrane of this comparative example was measured for the characteristics in the same manner as in Example 1. The measurement results are shown in Table 1-2.

### COMPARATIVE EXAMPLE 2

The block copolymer b obtained in (6) in Example 1 was dissolved in NMP to a concentration of 16% by weight. The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was observed for the phase-separated structures, and the microscopic phase-separated structure in nanometer order was found as similar to Comparative Example 1, but the contrast in brightness with a size of several micrometers, which was found in the polymer electrolyte membrane of Example 1, was not found.

The polymer electrolyte membrane of this comparative example was measured for the characteristics in the same manner as in Example 1. The measurement results are shown in Table 1-2.

### COMPARATIVE EXAMPLE 3

The block copolymer a obtained in (3) and the block copolymer b obtained in (6) both in Example 1 were dissolved in NMP at a ratio of 5/1 (total solid fraction: 16% by weight). The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was observed for the phase-separated structures, and the microscopic phase-separated structure in nanometer order was found as similar to Comparative Example 1, but the contrast in brightness with a size of several micrometers, which was found in the polymer electrolyte membrane of Example 1, was not found.

The polymer electrolyte membrane of this comparative example was measured for the characteristics in the same manner as in Example 1. The measurement results are shown in Table 1-2.

### COMPARATIVE EXAMPLE 4

### (1) Production of Block Copolymer d

In the same manner as in (3) of Example 1, the polymer a synthesized in (1) and the polymer b synthesized in (2) both in Example 1 were mixed and reacted at 140° C. for 2.5 hours. The mixing ratio of the polymer a and the polymer b was determined to make an ion exchange capacity of 1.60 meq/g. The resulting block copolymer d had a number average molecular weight Mn of 1.9×10⁵ and a weight average molecular weight Mw of 7.6×10⁵. The ion exchange capacity thereof measured by acid-base titration was 1.46 meq/g.

### (2) Production of Polymer Electrolyte Membrane and Characteristics Thereof

The block copolymer a obtained in (3) in Example 1 and the block copolymer d obtained in (1) above were dissolved in NMP at a ratio of 4/5 (total solid fraction: 16% by weight). The solution was flow-cast by coating on a glass plate, followed by drying under heating, and the membrane was then immersed in sulfuric acid and water, followed by drying, thereby providing a polymer electrolyte membrane having a thickness of 45 μm.

The resulting polymer electrolyte membrane was observed for the phase-separated structures, and the microscopic phase-separated structure in nanometer order was found as similar to Comparative Example 1, but the contrast in brightness with a size of several micrometers, which was found in the polymer electrolyte membrane of Example 1, was not found.

The polymer electrolyte membrane of this comparative example was measured for the characteristics in the same manner as in Example 1. The measurement results are shown in Table 1-2.

TABLE 1-1

| | | | Example 1 | Example 2 | Example 3 | Example 4 |
|---|---|---|---|---|---|---|
| Block | Hydrophobic segment | Average molecular weight Mn | 2.0 × 10⁴ | 2.0 × 10⁴ | 2.0 × 10⁴ | 2.0 × 10⁴ |
| copolymer A | | (Weight average molecular weight Mw) | (4.4 × 10⁴) | (4.4 × 10⁴) | (4.4 × 10⁴) | (4.4 × 10⁴) |
| | Hydrophilic segment | Average molecular weight Mn | 3.3 × 10⁴ | 3.3 × 10⁴ | 3.3 × 10⁴ | 3.3 × 10⁴ |
| | | (Weight average molecular weight Mw) | (8.1 × 10⁴) | (8.1 × 10⁴) | (8.1 × 10⁴) | (8.1 × 10⁴) |
| | Total | Average molecular weight Mn | 1.1 × 10⁵ | 1.1 × 10⁵ | 1.1 × 10⁵ | 1.1 × 10⁵ |
| | | (Weight average molecular weight Mw) | (4.4 × 10⁵) | (4.4 × 10⁵) | (4.4 × 10⁵) | (4.4 × 10⁵) |
| | Ion exchange capacity (meq/g) | | 1.46 | 1.46 | 1.46 | 1.46 |
| Block | Hydrophobic segment | Average molecular weight Mn | 1.2 × 10⁴ | 1.2 × 10⁴ | 1.2 × 10⁴ | 2.0 × 10⁴ |
| copolymer B | | (Weight average molecular weight Mw) | (2.5 × 10⁴) | (2.5 × 10⁴) | (2.5 × 10⁴) | (4.4 × 10⁴) |
| | Hydrophilic segment | Average molecular weight Mn | 2.6 × 10⁴ | 2.6 × 10⁴ | 2.6 × 10⁴ | 3.3 × 10⁴ |
| | | (Weight average molecular weight Mw) | (5.8 × 10⁴) | (5.8 × 10⁴) | (5.8 × 10⁴) | (8.1 × 10⁴) |
| | Total | Average molecular weight Mn | 9.3 × 10⁴ | 9.3 × 10⁴ | 9.3 × 10⁴ | 1.0 × 10⁵ |
| | | (Weight average molecular weight Mw) | (2.3 × 10⁵) | (2.3 × 10⁵) | (2.3 × 10⁵) | (3.9 × 10⁵) |

| | | | | |
|---|---|---|---|---|
| Ion exchange capacity (meq/g) | 0.93 | 0.93 | 0.93 | 1.02 |

| | | | | |
|---|---|---|---|---|
| Mixing ratio (A/B) | 4/5 | 3/7 | 1/3 | 4/5 |
| Microscopic phase separation | found | found | found | found |
| Macroscopic phase separation | found | found | found | found |
| Dimensional change | 2% | 2% | 1% | 2% |
| Ionic conductivity (S/cm) | 8.9 × 10⁻² | 8.6 × 10⁻² | 8.2 × 10⁻² | 9.3 × 10⁻² |
| Methanol crossover coefficient | 12.2 | 11.2 | 10.5 | 13.3 |
| (mg · μm/cm² · min · mg) | | | | |

TABLE 1-2

| | | | Comparative | Comparative | Comparative | Comparative |
|---|---|---|---|---|---|---|
| | | | Example 1 | Example 2 | Example 3 | Example 4 |
| Block | Hydrophobic segment | Average molecular weight Mn | 2.0 × 10⁴ | — | 2.0 × 10⁴ | 2.0 × 10⁴ |
| copolymer A | | (Weight average molecular weight Mw) | (4.4 × 10⁴) | | (4.4 × 10⁴) | (4.4 × 10⁴) |
| | Hydrophilic segment | Average molecular weight Mn | 3.3 × 10⁴ | — | 3.3 × 10⁴ | 3.3 × 10⁴ |
| | | (Weight average molecular weight Mw) | (8.1 × 10⁴) | | (8.1 × 10⁴) | (8.1 × 10⁴) |
| | Total | Average molecular weight Mn | 1.1 × 10⁵ | — | 1.1 × 10⁵ | 1.1 × 10⁵ |
| | | (Weight average molecular weight Mw) | (4.4 × 10⁵) | | (4.4 × 10⁵) | (4.4 × 10⁵) |
| | Ion exchange capacity (meq/g) | | 1.46 | — | 1.46 | 1.46 |
| Block | Hydrophobic segment | Average molecular weight Mn | — | 1.2 × 10⁴ | 1.2 × 10⁴ | 2.0 × 10⁴ |
| copolymer B | | (Weight average molecular weight Mw) | | (2.5 × 10⁴) | (2.5 × 10⁴) | (4.4 × 10⁴) |
| | Hydrophilic segment | Average molecular weight Mn | — | 2.6 × 10⁴ | 2.6 × 10⁴ | 3.3 × 10⁴ |
| | | (Weight average molecular weight Mw) | | (5.8 × 10⁴) | (5.8 × 10⁴) | (8.1 × 10⁴) |
| | Total | Average molecular weight Mn | — | 9.3 × 10⁴ | 9.3 × 10⁴ | 1.9 × 10⁵ |
| | | (Weight average molecular weight Mw) | | (2.3 × 10⁵) | (2.3 × 10⁵) | (7.6 × 10⁵) |

| | | | | |
|---|---|---|---|---|
| Ion exchange capacity (meq/g) | — | 0.93 | 0.93 | 1.46 |

| | | | | |
|---|---|---|---|---|
| Mixing ratio (A/B) | — | — | 5/1 | 4/5 |
| Microscopic phase separation | found | found | found | found |
| Macroscopic phase separation | none | none | none | none |
| Dimensional change | 4% | 1% | 4% | 4% |
| Ionic conductivity (S/cm) | 9.5 × 10⁻² | 1.1 × 10⁻² | 9.4 × 10⁻² | 9.4 × 10⁻² |
| Methanol crossover coefficient | 29.2 | 7.0 | 28.0 | 29.0 |
| (mg · μm/cm² · min · mg) | | | | |

In Comparative Examples 1 and 2, in which one block copolymer is used solely, the macroscopic phase-separated structure in micrometer order is not formed, but in Examples 1 to 4, in which two kinds of block copolymers having different ion exchange capacities are used, not only the microscopic phase-separated structure in nanometer order, but also the macroscopic phase-separated structure in micrometer order are formed. It is thus found that the solid polymer electrolyte membranes having both the microscopic phase-separated structure and the macroscopic phase-separated structure as in Examples 1 to 4 have a dimensional change and methanol crossover characteristics that are better than Comparative Example 1, while maintaining an ionic conductivity that is equivalent to the solid polymer electrolyte membrane of Comparative Example 1. It is considered that these advantages are obtained by the following mechanisms. In a solid polymer electrolyte membrane, the hydrophilic segment absorbs water to swell the solid polymer electrolyte membrane, whereby the solid polymer electrolyte membrane undergoes dimensional change, and the swelling of the hydrophilic segment promotes methanol permeation. On the other hand, the solid polymer electrolyte membranes of Examples 1 to 4 have the macroscopic phase-separated structure in micrometer order, in which the region A having mainly the block copolymer with a larger ion exchange capacity agglomerated therein is dispersed in the matrix constituted by the region B having mainly the block copolymer with a smaller ion exchange capacity. The region B as the matrix is constituted by the block copolymer b or the block copolymer c having a smaller ion exchange capacity, and thus undergoes less swelling. This is also apparent from the results of Comparative Example 1 constituted by the block copolymer a and Comparative Example 2 constituted by the block copolymer b. The region A is liable to be swollen than the region B, but is surrounded by the firm skeleton in micrometer order constituted by the region B, which undergoes less swelling, and therefore, the swelling of the region A is suppressed thereby. Consequently, the dimensional change may be suppressed, and the methanol permeation may be considerably lowered. In general, like Comparative Examples 1 and 2, the methanol crossover and the ionic conductivity are in a trade-off relationship, i.e., decreasing the methanol crossover increases the proton conductivity, whereas enhancing the proton conductivity increases the methanol crossover. On the other hand, in the solid polymer electrolyte membranes of Examples 1 to 4 formed by mixing two kinds of the block copolymers having different ion exchange capacities, the dimensional change and the methanol crossover can be decreased advantageously while maintaining the ionic conductivity.

Comparative Example 3 is a solid polymer electrolyte membrane that is formed by mixing two kinds of the block copolymers having different ion exchange capacities as similar to Examples 1 to 4, but there is no macroscopic phase-separated structure in micrometer order found, and the ionic conductivity, the dimensional change and the methanol crossover are not achieved simultaneously unlike Examples 1 to 4. In Comparative Example 3, it is considered that the block copolymer B is incorporated into the phase-separated structure of the block copolymer A since the mixing ratio of the block copolymer B is as small as approximately 17%. Accordingly, as for the mixing ratio of the block copolymer A having a larger ion exchange capacity and the block copolymer B having a smaller ion exchange capacity, the mixing ratio of the block copolymer A is preferably 20% or more, and more preferably 25% or more, based on the total amount of the block copolymer A and the block copolymer B.

Comparative Example 4 is a solid polymer electrolyte membrane that is formed by mixing two kinds of the block copolymers having the equivalent ion exchange capacities but different molecular weights, but there is no macroscopic phase-separated structure in micrometer order found, and the ionic conductivity, the dimensional change and the methanol crossover are not achieved simultaneously unlike Examples 1 to 4. In Comparative Example 4, it is considered that the macroscopic phase separation does not occur since two kinds of the block copolymers having the equivalent ion exchange capacities are compatible to each other.

It is understood from the results above that the solid polymer electrolyte membrane of the invention having such a phase-separated structure that has both microscopic phase separation and macroscopic phase separation can be largely decreased in the dimensional change and the methanol crossover while maintaining the ionic conductivity. Accordingly, enhancement of reliability of a fuel cell and significant enhancement of efficiency thereof are expected by applying the solid polymer electrolyte membrane of the invention thereto.

What is claimed is:

1. A solid polymer electrolyte membrane comprising:
a block copolymer A containing a hydrophilic segment having an ion exchange group and a hydrophobic segment, and
a block copolymer B containing a hydrophilic segment having an ion exchange group and a hydrophobic segment and having a smaller ion exchange capacity than the block copolymer A, and
having a structure where a region A having the block copolymer A agglomerated therein is dispersed in a matrix constituted by a region B having the block copolymer B agglomerated therein,
with a microscopic phase-separated structure having a period of from 10 to 100 nm being formed in the region A and the region B.

2. The solid polymer electrolyte membrane according to claim 1, wherein a mixing ratio of the block copolymer A is 20% or more based on the total amount of the block copolymer A and the block copolymer B.

3. The solid polymer electrolyte membrane according to claim 1, wherein the solid polymer electrolyte membrane has a total ion exchange capacity of from 0.3 to 5.0 meq/g.

4. A solid polymer electrolyte membrane having a microscopic phase-separated structure of a block copolymer containing a hydrophilic segment having an ion exchange group and a hydrophobic segment,
having a structure containing a matrix and dispersed therein a region having a larger ion exchange capacity than the matrix, with the microscopic phase-separated structure having a period of from 10 to 100 nm being formed in the matrix and the region.

5. The solid polymer electrolyte membrane according to claim 4, wherein the solid polymer electrolyte membrane is formed by coating a solution containing a block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A dissolved in a solvent, on a flat plate, and heating and drying to form the membrane.

6. A membrane-electrode assembly comprising the solid polymer electrolyte membrane according to claim 1, having a cathode formed on one surface thereof and an anode formed on the other surface thereof.

7. A fuel cell comprising the membrane-electrode assembly according to claim 6.

8. A membrane-electrode assembly comprising the solid polymer electrolyte membrane according to claim 4, having a cathode formed on one surface thereof and an anode formed on the other surface thereof.

9. A fuel cell comprising the membrane-electrode assembly according to claim 8.

10. A method for producing a solid polymer electrolyte membrane having a microscopic phase-separated structure of a block copolymer containing a hydrophilic segment having an ion exchange group and a hydrophobic segment,
the method comprising the steps of:
coating a solution containing a block copolymer A containing a hydrophilic segment having an ion exchange group and a hydrophobic segment, and a block copolymer B containing a hydrophilic segment having an ion exchange group and a hydrophobic segment and having a smaller ion exchange capacity than the block copolymer A dissolved in a solvent, on a flat plate, and
heating and drying the solution having been coated on the flat plate, to form the membrane.
